(19) United States
(12) Patent Application Publication
(10) Pub. No.: US 2025/0187085 A1
(43) Pub. Date: Jun. 12, 2025

(54) SPADE DRILL BLADE AND COMBINED BLADE

(71) Applicant: Shiqing LI, Xintai Taian (CN)

(72) Inventor: Shiqing LI, Xintai Taian (CN)

(21) Appl. No.: 18/844,690

(22) PCT Filed: Mar. 8, 2023
(86) PCT No.: PCT/CN2023/080308

§ 371 Date: Sep. 6, 2024

(30) Foreign Application Priority Data
Mar. 8, 2022 (CN) 202210230899.0
Mar. 8, 2022 (CN) 202210230900.X

(51) Int. Cl. B23B 51/02

(52) U.S. Cl. CPC B23B 51/02; B23B 2251/12

(57) ABSTRACT

Provide are a spade drill blade and a combined blade. The spade drill blade includes cutting surfaces, cutting grooves, rear cutting surfaces, secondary cutting surfaces, cutting edges, secondary edges, a chisel edge, and side edges. One or more micro strengthened stepping tables are integrally erected on the cutting surface and each intersect with the rear cutting surface to form a micro strengthened side cutting edge; and a protruding stepped cutting surface is integrally formed on an inner side of each micro strengthened stepping table and intersects with the rear cutting surface to form a stepped cutting edge. On a cutting surface of the combined blade, one or more micro strengthened stepping tables are integrally erected in an axial direction of a rotation center of the combined blade and each intersect with the rear cutting surface to form a micro strengthened side cutting edge.

### CROSS-REFERENCE TO RELATED APPLICATION

This application is a national stage application of International Patent Application No. PCT/CN2023/080308, filed on Mar. 8, 2023, which claims priority of the Chinese Patent Application Nos. 202210230899.0, 202210230900.X, both filed on Mar. 8, 2022, all of which are incorporated by references in their entities.

### TECHNICAL FIELD

The present disclosure relates to a spade drill blade and a combined blade, which are used in drilling and milling process of machining and bench worker maintenance.

### BACKGROUND

At present, the spade drill blade used in machining is composed of a chisel edge, two cutting edges, and a side edge. The cutting edge is located on a cutting surface and is of a single co-located cutting structure. The cutting edge is in the centrifugal force transmission range of rotary cutting, and is subjected to a rotary cutting force and a centrally outward transmission force at the same time. The cutting lip at the intersection of the cutting edge and the cutting edge is always easy to be damaged under the action of double forces. An existing hole machining tool swings since the structure is not absolutely balanced during drilling. The cutting surface and cutting edge will be damaged if the tool is stabilized only by the cutting surface. People generally think that the smoother the surface, the higher the strength, and the new theory is that the strength of the surface with tiny gaps is higher, both of which do not reveal the essential structural characteristics of matter. Therefore, the existing hole machining tool is low in efficiency, easy to damage, low in stability and poor in drilling precision.

At present, the combined blade used in machining is composed of a chisel edge, a cutting edge, a cutting edge, and a side edge. The cutting edge is located on a cutting surface and is of a single co-located cutting structure. The cutting edge is in the centrifugal force transmission range of rotary cutting, and is subjected to a rotary cutting force and a centrally outward transmission force at the same time. The cutting lip at the intersection of the cutting edge and the cutting edge is always easy to be damaged under the action of double forces. An existing hole machining tool swings since the structure is not absolutely balanced during drilling. The cutting surface and cutting edge will be damaged if the tool is stabilized only by the cutting surface. People generally think that the smoother the surface, the higher the strength, and the new theory is that the strength of the surface with tiny gaps is higher, both of which do not reveal the essential structural characteristics of matter. Therefore, the existing hole machining tool is low in efficiency, easy to damage, low in stability and poor in drilling precision.

### SUMMARY

The present disclosure is provided in view of one of above problems, and has an objective of providing a spade drill blade. Such a tool has an ability of blocking a transmission force, high heat dissipation efficiency, high strength, long service, ability of positioning easily during drilling, and high drilling accuracy. It is generally recognized that the smoother the surface, the higher the strength, and the new theory is that the strength of the surface with tiny gaps is higher, both of which do not reveal the essential structural characteristics of matter. In a case that two solids have the same volume, the surface area of the dispersed small-volume solid is larger than that of the whole solid, and when an overall structure of the solid reaches a certain volume limit, even the diamond will break. The sum of the force intensity on the small-volume solid is much greater than that of the whole solid according to the force on the volume. It is verified by experiments that the millimeter scale has the most significant high strength characteristic, i.e., millimeter strength, on the cutting tool in the conventional physical state. The present disclosure is the application of a spade drill blade with millimeter strength.

To achieve the objective above, the technical solution adopted by the present disclosure is as follows:

A spade drill blade relates to a drilling tool for machining. Cutting surfaces are formed on surfaces, facing a cutting direction along an axial center, of the spade drill blade, a cutting groove is integrally formed on a bottom of each cutting surface; and the cutting surfaces are formed on surfaces, facing the cutting direction and along a rotation direction around the axial center, of the spade drill blade; surfaces facing away from the rotation direction on a top end of the spade drill blade are rear cutting surfaces, and surfaces facing the rotation direction on an outer side of the spade drill blade are secondary cutting surfaces; each cutting surface intersects with a corresponding rear cutting surface to form a cutting edge, each cutting surface intersects with a corresponding secondary cutting surface to form a secondary edge, the rear cutting surfaces on at least two sides of the spade drill blade intersect to form a chisel edge, and each secondary cutting surface intersects with a corresponding rear cutting surface to form a side edge; a micro strengthened stepping table is integrally erected on each cutting surface of the spade drill blade, a protruding stepped cutting surface is integrally formed on an inner side of the micro strengthened stepping table; the micro strengthened stepping table intersects with the corresponding rear cutting surface to form a micro strengthened side cutting edge; the stepped cutting surface intersects with the corresponding rear cutting surface to form a stepped cutting edge; the rear cutting surfaces on both sides of the spade drill blade intersect at the axial center to form the chisel edge; both sides of the chisel edge are chamfered to form chamfered cutting surfaces, chamfered edges, and a top edge; and the spade drill blade is provided with positioning boles, and a positioning groove.

A spade drill blade relates to a drilling tool for machining. Cutting surfaces are formed on surfaces, facing a cutting direction along an axial center, of the spade drill blade, a cutting groove is integrally formed on a bottom of each cutting surface; and the cutting surfaces are formed on surfaces, facing the cutting direction and along a rotation direction around the axial center, of the spade drill blade; surfaces facing away from the rotation direction on a top end of the spade drill blade are rear cutting surfaces, and surfaces facing the rotation direction on an outer side of the spade drill blade are secondary cutting surfaces; each cutting surface intersects with a corresponding rear cutting surface to form a cutting edge, each cutting surface intersects with a corresponding secondary cutting surface to form a secondary edge, the rear cutting surfaces on at least two sides of the spade drill blade intersect to form a chisel edge, and each secondary cutting surface intersects with a corresponding rear cutting surface to form a side edge; multiple micro strengthened stepping tables are integrally erected on each cutting surface of the blade, a protruding stepped cutting surface is integrally formed on an inner side of each micro strengthened stepping table; each micro strengthened stepping table intersects with the corresponding rear cutting surface to form a micro strengthened side cutting edge; the stepped cutting surface intersects with the corresponding rear cutting surface to form a stepped cutting edge; the rear cutting surfaces on both sides of the spade drill blade intersect at the axial center to form the chisel edge; both sides of the chisel edge are chamfered to form chamfered cutting surfaces, chamfered edges, and a top edge; and the spade drill blade is provided with positioning holes, and a positioning groove.

A spade drill blade relates to a drilling tool for machining. Cutting surfaces are formed on surfaces, facing a cutting direction along an axial center, of the spade drill blade, a cutting groove is integrally formed on a bottom of each cutting surface; and the cutting surfaces are formed on surfaces, facing the cutting direction and along a rotation direction around the axial center, of the spade drill blade; surfaces facing away from the rotation direction on a top end of the spade drill blade are rear cutting surfaces, and surfaces facing the rotation direction on an outer side of the spade drill blade are secondary cutting surfaces; each cutting surface intersects with a corresponding rear cutting surface to form a cutting edge, each cutting surface intersects with a corresponding secondary cutting surface to form a secondary edge, the rear cutting surfaces on at least two sides of the spade drill blade intersect to form a chisel edge, and each secondary cutting surface intersects with a corresponding rear cutting surface to form a side edge; multiple micro strengthened stepping tables are integrally erected on each cutting surface of the spade drill blade, a protruding stepped cutting surface is integrally formed on an inner side of each micro strengthened stepping table; each micro strengthened stepping table intersects with the corresponding rear cutting surface to form a micro strengthened side cutting edge; the stepped cutting surface intersects with the corresponding rear cutting surface to form a stepped cutting edge; the cutting edge of the spade drill blade is provided with a notched edge, the notched edge extends towards the corresponding rear cutting surface to form a groove; the rear cutting surfaces on both sides of the spade drill blade intersect at the axial center to form the chisel edge; both sides of the chisel edge are chamfered to form chamfered cutting surfaces, chamfered edges, and a top edge; and the spade drill blade is provided with positioning holes, and a positioning groove.

Preferably, the spade drill blade is provided with at least one step, of which a height on the corresponding rear cutting surface reduces from the chisel edge at a central towards the side edge at the outer side.

Preferably, the cutting edge of the spade drill blade is provided with at least one notched edge, and the notched edge extends towards the corresponding rear cutting surface to form at least one groove.

Preferably, the rear cutting surfaces on both sides of the spade drill blade intersect at the axial center to form the chisel edge, and both sides of the chisel edge are chamfered to form a top edge used as a reduced chisel edge.

Preferably, the rear cutting surfaces on both sides of the spade drill blade intersect at the axial center to form the chisel edge, and both sides of the chisel edge are chamfered to form a top edge used as a sharp edge without a chisel edge.

Preferably, cooling holes are formed in strips of a tool shank and a tool head of the spade drill blade.

Preferably, the spade drill blade is provided with multiple steps, of which heights on the corresponding rear cutting surface reduce from the chisel edge at a central towards the side edge at the outer side.

Preferably, the cutting edge of the spade drill blade is provided with a plurality of notched edges, and the plurality of notched edges extend towards the corresponding rear cutting surface to form a plurality of grooves.

$

Preferably, a central plane of a step, a tapping cutting surface or a micro section with millimeter strength is provided as a groove shape in the axial direction.

Preferably, an included angle between the cutting edge at the outermost side of the spade drill blade and the secondary cutting edge is an acute angle, a right angle, or an obtuse angle.

The present disclosure also has an objective of providing a combined blade. Such a tool has an ability of blocking a transmission force, high heat dissipation efficiency, high strength, long service, ability of positioning easily during drilling, and high drilling accuracy. It is generally recognized that the smoother the surface, the higher the strength, and the new theory is that the strength of the surface with tiny gaps is higher, both of which do not reveal the essential structural characteristics of matter. In a case that two solids have the same volume, the surface area of the dispersed small-volume solid is larger than that of the whole solid, and when an overall structure of the solid reaches a certain volume limit, even the diamond will break. The sum of the force intensity on the small-volume solid is much greater than that of the whole solid according to the force on the volume. It is verified by experiments that the millimeter scale has the most significant high strength characteristic, i.e., millimeter strength, on the cutting tool in the conventional physical state. The present disclosure is the application of a combined blade with millimeter strength.

To achieve the objective above, the technical solution adopted by the present disclosure is as follows;

A combined blade is provided. At least two combined blades are fixed to a combined tool for machining by screws, each combined blade is integrally composed of structures in at least one or more cutting directions, a structure in each cutting direction complete independently partial cutting operation of the combined tool, and cutting surfaces are formed on surfaces, facing the cutting direction, of the combined blade: a cutting groove is integrally formed on a bottom of each cutting surface, and the cutting surfaces are formed on surfaces, facing a front of a rotation direction, of the combined blade; surfaces facing away from the rotation direction on a top end of the combined blade are rear cutting surfaces, and each cutting surface intersects with a corresponding rear cutting surface to form a cutting edge; on each cutting surface of the combined blade, a micro strengthened stepping table is integrally erected in an axial direction of the rotation center of the combined tool, and a protruding stepped cutting surface is integrally formed on an inner side of the micro strengthened stepping table; the structures of the combined blade in the cutting directions are all structures of the combined blade which participate in cutting or secondary cutting in the combined tool at the same time; the micro strengthened stepping table intersects with the corresponding rear cutting surface to form a side cutting edge; the stepped cutting surface intersects with the corresponding rear cutting surface to form a micro strengthened stepped cutting edge, and the combined blade is provided with positioning holes.

A combined blade is provided. At least two combined blades are fixed to a combined tool for machining by screws, each combined blade is integrally composed of structures in at least one or more cutting directions, a structure in each cutting direction complete independently partial cutting operation of the combined tool, and cutting surfaces are formed on surfaces, facing the cutting direction, of the combined blade; a cutting groove is integrally formed on a bottom of each cutting surface, and the cutting surfaces are formed on surfaces, facing a front of a rotation direction, of the combined blade; surfaces facing away from the rotation direction on a top end of the combined blade are rear cutting surfaces, and each cutting surface intersects with a corresponding rear cutting surface to form a cutting edge; on each cutting surface of the combined blade, multiple micro strengthened stepping tables are integrally erected in an axial direction of the rotation center of the combined tool, and a protruding stepped cutting surface is integrally formed on an inner side of each micro strengthened stepping table; the structures of the combined blade in the cutting directions are all structures of the combined blade which participate in cutting or secondary cutting in the combined tool at the same time; each micro strengthened stepping table intersects with the corresponding rear cutting surface to form a side cutting edge; the stepped cutting surface intersects with the corresponding rear cutting surface to form a micro strengthened stepped cutting edge, and the combined blade is provided with positioning holes.

A combined blade is provided. At least two combined blades are fixed to a combined tool for machining by screws, each combined blade is integrally composed of structures in at least one or more cutting directions, a structure in each cutting direction complete independently partial cutting operation of the combined tool, and cutting surfaces are formed on surfaces, facing the cutting direction, of the combined blade; a cutting groove is integrally formed on a bottom of each cutting surface, and the cutting surfaces are formed on surfaces, facing a front of a rotation direction, of the combined blade; surfaces facing away from the rotation direction on a top end of the combined blade are rear cutting surfaces, and each cutting surface intersects with a corresponding rear cutting surface to form a cutting edge; on each cutting surface of the combined blade, multiple micro strengthened stepping tables are integrally erected in an axial direction of the rotation center of the combined tool, and a protruding stepped cutting surface is integrally formed on an inner side of each micro strengthened stepping table; the structures of the combined blade in the cutting directions are all structures of the combined blade which participate in cutting or secondary cutting in the combined tool at the same time; each micro strengthened stepping table intersects with the corresponding rear cutting surface to form a side cutting edge; the stepped cutting surface intersects with the corresponding rear cutting surface to form a micro strengthened stepped cutting edge; the cutting edge of the combined blade is provided with a notched edge, the notched edge extends towards the corresponding rear cutting surface to form a groove, and the combined blade is provided with positioning holes.

Preferably, the combined blade is provided with at least one step, of which a height on the corresponding rear cutting surface of the combined blade reduces from a position adjacent to the axial center towards an outer side of the combined tool.

Preferably, the cutting edge of the combined blade is provided with at least one notched edge, and the notched edge extends towards the corresponding rear cutting surface to form at least one groove.

Preferably, the combined blade is generally a triangular configuration with structures in three cutting directions, one end of a structure in each cutting direction is adjacent to a central position of the combined tool, and another end of the structure in each cutting direction is adjacent to an outer side of the combined tool.

Preferably, the combined blade is generally a quadrangular configuration with structures in four cutting directions, one end of a structure in each cutting direction is adjacent to a central position of the combined tool, and another end of the structure in each cutting direction is adjacent to an excircle position of the combined tool.

Preferably, the combined blade is provided with a structure in at least one cutting direction, and the structure in the cutting direction comprises a cutting edge, a notched edge, or a stepped edge.

Preferably, the combined blade is provided with multiple steps, of which heights on the corresponding rear cutting surface reduce from the chisel edge at a central towards the side edge at the outer side.

Preferably, the cutting edge of the combined blade is provided with a plurality of notched edges, and the plurality of notched edges extend towards the corresponding rear cutting surface to form a plurality of grooves.

The present disclosure has the beneficial effects that:

In a contrast experiment carried out on a drilling machine, a twist drill with a diameter of 10.15 is tested, in a case that the material of the spade drill blade is the same, a drilled object is a gear finish turning machining piece that has been forged and tempered, a drilling depth is 35 mm, and blind holes are formed. In a case that the rotating speed and the feed rate of an ordinary spade drill blade with a common structure reach the limit, the rotating speed of the spade drill blade provided by the present disclosure can be increased by 35%, the feed rate can be improved by 50%, and the comprehensive drilling efficiency can be improved by one or more times. Compared with the twist drill with a common structure, the number of holes drilled by the spade drill blade is increased by at least a dozen times.

In a contrast experiment carried out on a drilling machine, a twist drill with a diameter of 10.15 is tested, in a case that the material of the combined blade is the same, a drilled object is a gear finish turning machining piece that has been forged and tempered, a drilling depth is 35 mm, and blind holes are formed. In a case that the rotating speed and the feed rate of an ordinary combined blade with a common structure reach the limit, the rotating speed of the combined blade provided by the present disclosure can be increased by 35%, the feed rate can be improved by 50%, and the comprehensive drilling efficiency can be improved by one or more times. Compared with the twist drill with a common structure, the number of holes drilled by the combined blade is increased by at least a dozen times.

### BRIEF DESCRIPTION OF THE DRAWINGS

The technical solutions and advantages of the present disclosure are described in detail with reference to the accompanying drawings. In the drawings:

FIG. 1 is a front view of a spade drill blade according to the present disclosure;

FIG. 2 is a schematic diagram of a spade drill blade according to a first solution of a first embodiment of the present disclosure;

FIG. 3 is a schematic diagram of a spade drill blade according to a second solution of a first embodiment of the present disclosure;

FIG. 4 is a schematic diagram of a spade drill blade according to a third solution of a first embodiment of the present disclosure;

FIG. 5 is a schematic diagram of a spade drill blade according to a first solution of a second embodiment of the present disclosure;

FIG. 6 is a schematic diagram of a spade drill blade according to a second solution of a second embodiment of the present disclosure;

FIG. 7 is a schematic diagram of a spade drill blade according to a third solution of a second embodiment of the present disclosure;

FIG. 8 is a top view of a triangular combined blade according to the present disclosure;

FIG. 9 is a top view of a quadrangular combined blade according to the present disclosure;

FIG. 10 is a left view of a combined blade according to the present disclosure;

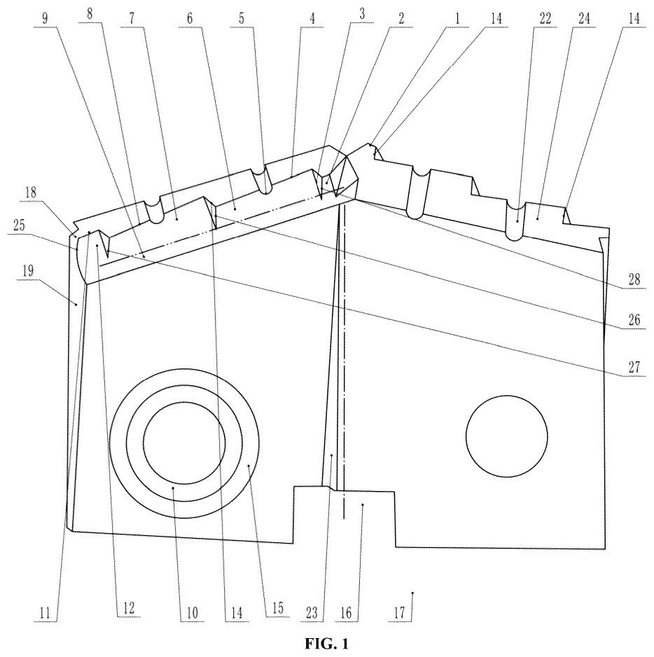

FIG. 1l is a right view of a combined blade according to the present disclosure;

FIG. 12 is a front view of a combined blade according to the present disclosure;

FIG. 13 is a rear view of a combined blade according to the present disclosure.

In the drawing: 1, micro strengthened center edge; 2, micro strengthened central plane; 3, micro strengthened stepping table; 4, micro strengthened tapping edge; 5, notched edge; 6, tapping cutting surface; 7, cutting surface; 8, cutting edge; 9, cutting groove; 10, positioning hole; 11, wear-resistant cutting edge; 12, wear-resistant cutting surface with recessed outer side; 14, micro strengthened side cutting edge; 15, inclined table; 16, positioning groove; 17, spade drill blade; 18, side cutting edge; 19, secondary cutting surface; 20, chamfered surface; 21, chamfered edge; 22, groove; 23, inclined plane; 24, rear cutting surface; 25, micro strengthened wear-resistant secondary edge: 26, micro strengthened tapping secondary edge; 27, wear-resistant stepping edge; 28, micro strengthened central secondary edge; 29, combined blade.

### DETAILED DESCRIPTION OF THE EMBODIMENTS

The preferred embodiments of a spade drill blade of the present disclosure are described in detail below with reference to the accompanying drawings. In a first embodiment to a third embodiment, a tool with two strips is used as an example for illustration. In a preferred embodiment of a combined blade 29, a triangular combined blade and a quadrangular combined blade with the structures in the cutting directions are mainly taken as examples for illustration in a fourth embodiment to a sixth embodiment. In each cutting process, the combined blade 29 has the structure in only cutting direction structure to participate in cutting operation, and the structures in other cutting directions are replacement for damage.

### First Embodiment

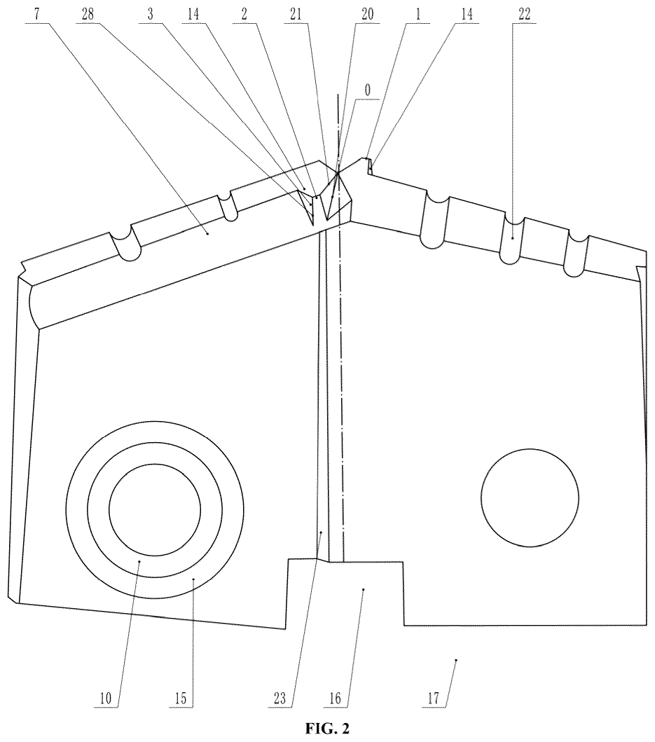

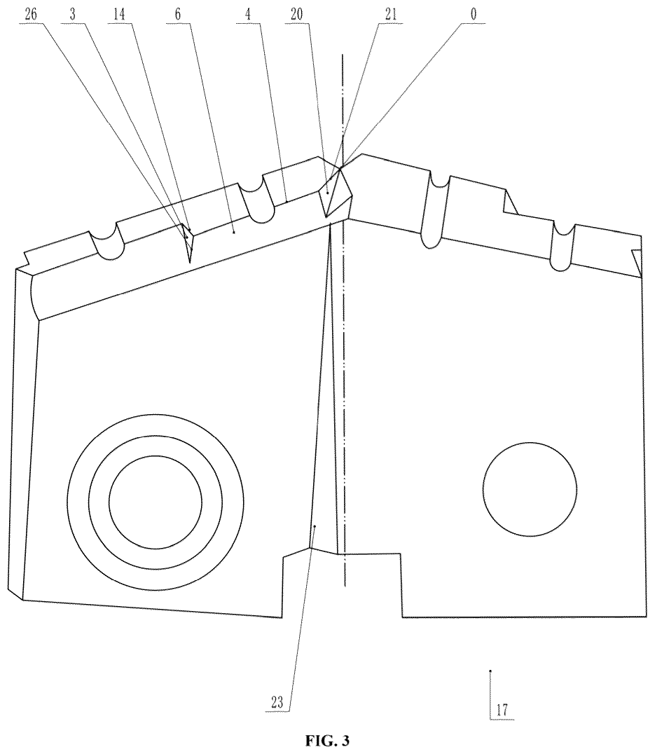

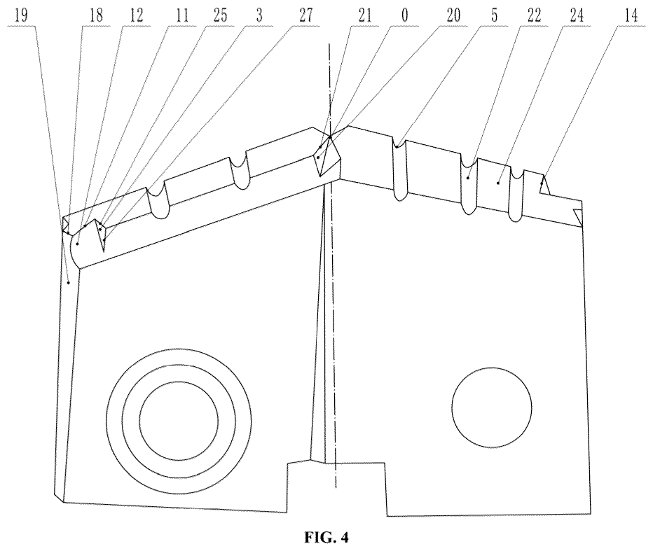

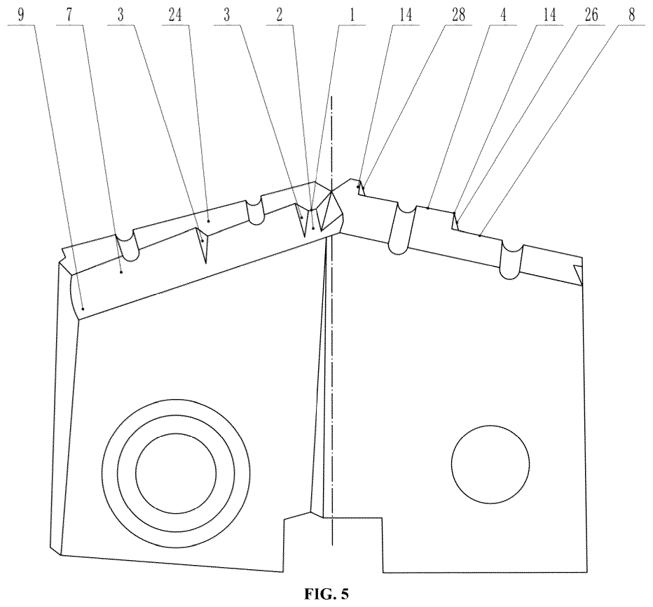

As shown in FIG. 1, FIG. 2 to FIG. 4, a spade drill blade 17 in this embodiment relates to a drilling tool for machining. Cutting surfaces 7 are formed on surfaces, facing a cutting direction along the axial center, of the spade drill blade 17, the bottom of each cutting surface 7 is integrally provided with a cutting groove 9, surfaces facing away from the rotation direction on a top end of the spade drill blade 17 are rear cutting surfaces 24, and surfaces facing the rotation direction on an outer side of the spade drill blade are secondary cutting surfaces 19. Each secondary cutting surface 19 intersects with a corresponding rear cutting surface 24 to form a side cutting edge 18, each cutting surface 7 intersects with the corresponding rear cutting surface 24 to form a cutting edge 8, each cutting surface 7 intersects with the secondary cutting surface 19 to form a secondary edge, the rear cutting surfaces on at least two sides intersect to form a chisel edge O, and each cutting surface 7 intersects with the secondary cutting surface 19 to form a side edge. A micro strengthened stepping table 3 is integrally erected on each cutting surface 7 of the spade drill blade 17, a protruding stepped cutting surface (a micro strengthened central plane 2, a tapping cutting surface 6, a wear-resistant cutting surface with recessed outer side) is integrally formed on an inner side of the micro strengthened stepping table 3. The micro strengthened stepping table 3 intersects with the corresponding rear cutting surface 24 to form a micro strengthened side cutting edge 14. The stepped cutting surface intersects with the corresponding rear cutting surface to form a stepped cutting edge (a micro strengthened center edge 1, a micro strengthened tapping edge 4, and a wear-resistant cutting edge 11). The rear cutting surfaces 24 on both sides of the spade drill blade 17 intersect at the axial center to form the chisel edge. Both sides of the chisel edge are chamfered to form chamfered cutting surfaces, chamfered edges, and a top edge O. The spade drill blade 17 is provided with positioning holes 10, and a positioning groove 16. An outer side of each positioning hole 10 is provided with an extended inclined table 15.

A surface in a front of a rotation direction of the spade drill blade 17 is inclined backwards to fit with the spade drill blade body to form an inclined plane 23.

The micro strengthened stepping table 3 arranged on the spade drill blade 17 may have three arrangement solutions, and the three arrangement solutions have completely different effects and results.

### First Solution:

On the cutting surface 7 of the spade drill blade 17 which rotates around the axial center, a spade drill blade 17 is formed in a way of arranging an erected micro strengthened stepping table 3 on the cutting surface at a position which has a distance from the axial center less than or equal to one third of a width of the cutting surface, and thus has the highest cutting efficiency. A protruding stepped cutting surface integrally formed on the inner side of the micro strengthened stepping table 3 is a micro strengthened central plane 2. The micro strengthened stepping table 3 intersects with the rear cutting surface 24 to form a micro strengthened center edge 1 (which is also called a micro strengthened cutting edge). The micro strengthened stepping table 3 intersects with the micro strengthened central plane 2 to form a micro strengthened central secondary edge 28.

A stepped cutting edge formed by the intersection of the micro strengthened central plane 2 and the rear cutting surface 24 is the micro strengthened center edge 1.

### Second Solution:

On the cutting surface 7 of the spade drill blade 17 which rotates around the axial center, a spade drill blade 17 is formed in a way of arranging an erected micro strengthened stepping table 3 on the cutting surface at a position which has a distance from the axial center less than or equal to two thirds and greater than or equal to one third of a width of the cutting surface, and thus has the highest drilling stability. A protruding stepped cutting surface integrally formed on the inner side of the micro strengthened stepping table 3 is a tapping cutting surface 6. The micro strengthened stepping table 3 intersects with the rear cutting surface to form a micro strengthened tapping edge 4. The micro strengthened stepping table 3 intersects with the tapping cutting surface to form a micro strengthened tapping secondary edge 26.

### Third Solution:

On the cutting surface 7 of the spade drill blade 17 which rotates around the axial center, a spade drill blade 17 is formed in a way of arranging an erected micro strengthened stepping table 3 on the cutting surface at a position which has a distance from the axial center greater than or equal to two thirds of the width of the cutting surface, and thus has the longest service life. A recessed micro strengthened cutting surface integrally formed on an outer side of the micro strengthened stepping table 3 is a wear-resistant cutting surface 12 with recessed outer side. The micro strengthened stepping table 3 intersects with the rear cutting surface to form a micro strengthened side cutting edge 14. The secondary cutting surface 19 intersects with the wear-resistant cutting surface to form a micro strengthened wear-resistant secondary edge 25. The micro strengthened stepping table 3 erected on the wear-resistant cutting surface 12 intersects with the cutting surface 7 to form a wear-resistant stepping edge 27. A stepped cutting edge formed by the intersection of the wear-resistant cutting surface 12 and the rear cutting surface 24 is a wear-resistant cutting edge 11.

In above arrangement solution, a structure of a groove formed by extending the notched edge 5, which is arranged on the cutting edge of the spade drill blade 17, towards the rear cutting surface can function to break chips in time, and further improve the efficiency and prolong the service life.

The rear cutting surfaces on both sides of one spade drill blade 17 intersect to form a chisel edge O, or both ends of the chisel edge O are chamfered to form chamfered cutting surfaces, an original chisel edge O with the chamfered edges is chamfered to form a reduced chisel edge O), or a sharp edge O without a chisel edge O. The reduction or elimination of the chisel edge greatly reduces the high resistance caused by overlong chisel edge.

A spade drill blade 17 is provided with at least one step, of which height on the corresponding rear cutting surface reduces from the chisel edge at a central towards the side edge at the outer side.

The cutting edge of the spade drill blade 17 is provided with at least one notched edge 5, and the notched edge 5 extends towards the corresponding rear cutting surface to form at least one groove 22.

The rear cutting surfaces on both sides of the spade drill blade 17 intersect at the axial center to form the chisel edge, and both sides of the chisel edge are chamfered to form a top edge used as a reduced chisel edge.

The rear cutting surfaces on both sides of the spade drill blade 17 intersect at the axial center to form the chisel edge, and both sides of the chisel edge are chamfered to form a top edge used as a sharp edge without a chisel edge.

Cooling holes are formed in strips of a tool shank and a tool head of the spade drill blade 17.

The spade drill blade 7 is provided with multiple steps (not shown), of which heights on the corresponding rear cutting surface 24 reduce from the chisel edge at a central towards the side edge at the outer side.

The cutting edge of the spade drill blade 17 is provided with multiple notched edges S, and the multiple notched edges 5 extend towards the corresponding rear cutting surface to form multiple grooves.

An included angle between the cutting edge at the outermost side of the spade drill blade 17 and the secondary cutting edge 25 is an acute angle or a right angle, or an obtuse angle.

According to the above structure, because cutting of drilling is a circular movement, a centrifugal force is generated in the process of the circular movement, the cutting edge forms a transmission carrier of a centrifugal force. The cutting edge is separated by a micro cutting edge, a side micro edge and a cutting micro edge, which are formed by the intersection of the cutting surface and an adjacent micro strengthened stepping table 3 and the intersection of a micro stepped cutting surface and the rear cutting surface, thus reducing the overall cutting resistance reducing the temperature of the tool head, decomposing the force on the cutting edge at the most easily damaged outer end of the tool, prolonging the service life of the tool, and maintaining high strength all the time during machining.

In a contrast experiment carried out on a drilling machine, a twist drill with a diameter of 10.5 is tested, and is also made of M35 cobalt-containing high-speed steel. Heat treatment and production in the same batch are carried out at the same time. A drilled object is a gear finish turning machining piece that has been forged and tempered, a drilling depth is 35 mm, and blind holes are formed. A width of a micro cutting surface of the spade drill blade 17 is 1.5 mm, and a height of the micro strengthened stepping table 3 is 0.6 mm. In a case that the rotating speed and the feed rate of the twist drill with a common structure reach the limit, the rotating speed of the spade drill blade 17 can be increased by 35%, the feed rate can be improved by 50%, and the comprehensive drilling efficiency can be improved by 1.05 times. 312 holes can be drilled by the twist drill with a common structure, and 3168 holes can be drilled by the spade drill blade 17. Compared with the twist drill with a common structure, the number of holes drilled by the spade drill blade 17 is increased by ten or more times.

According to the above experimental results, the use efficiency and service life of the twist drill are significantly improved, providing that this structure is an effective way for prolonging the service life and improving the efficiency.

### Second Embodiment

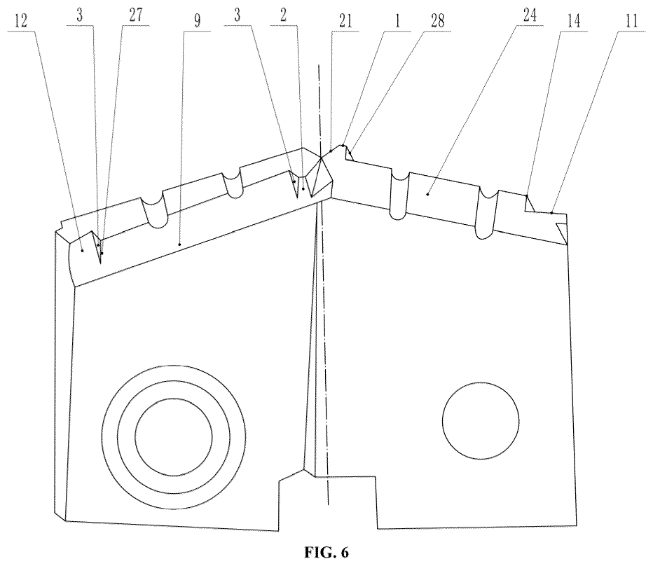

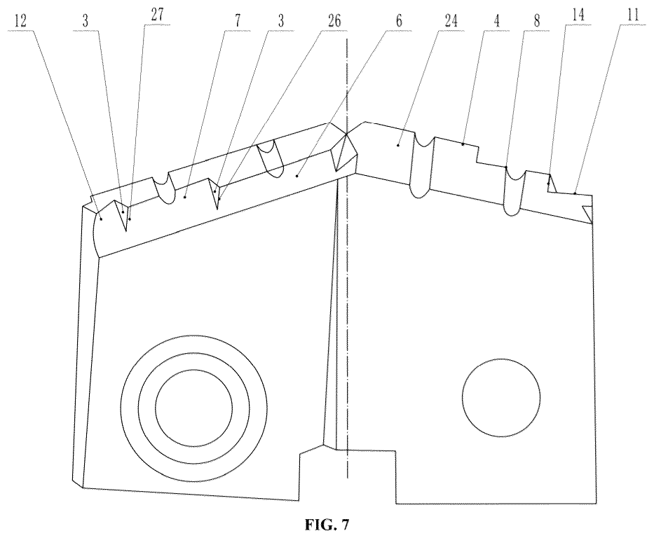

As shown in FIG. 1, FIG. 5 to FIG. 7, a spade drill blade 17 in this embodiment is a comprehensive application on the basis of the first embodiment, relating to a drilling tool for machining. Cutting surfaces 7 are formed on surfaces, facing a cutting direction along the axial center, of the blade 17, the bottom of each cutting surface 7 is integrally provided with a cutting groove 9, surfaces facing away from the rotation direction on a top end of the spade drill blade 17 are rear cutting surfaces 24, and surfaces facing the rotation direction on an outer side of the spade drill blade are secondary cutting surfaces 19. Each secondary cutting surface 19 intersects with the corresponding rear cutting surface 24 to form a side cutting edge 18, the cutting surface 7 intersects with the corresponding rear cutting surface 24 to form a cutting edge 8, each cutting surface 7 intersects with the secondary cutting surface 19 to form a secondary edge, the rear cutting surfaces on at least two sides intersect to form a chisel edge O, and each cutting surface 7 intersects with the secondary cutting surface 19 to form a side edge. Multiple micro strengthened stepping tables 3 are integrally erected on each cutting surface of the spade drill blade 17, and a protruding stepped cutting surface is integrally formed on an inner side of each micro strengthened stepping table 3. The multiple micro strengthened stepping tables 3 intersect with the corresponding rear cutting surface to form multiple micro strengthened side cutting edges. The multiple stepped cutting surfaces intersect with the corresponding rear cutting surface to form multiple stepped cutting edges. The rear cutting surfaces on both sides of the spade drill blade 17 intersect at the axial center to form the chisel edge. Both sides of the chisel edge are chamfered to form chamfered cutting surfaces, chamfered edges, and a top edge. The spade drill blade 17 is provided with positioning holes 10, and a positioning groove 16.

According to the present disclosure, two of the three arrangement solutions of the micro strengthened stepping table 3 arranged on the spade drill blade 17 can be combined, and the spade drill blade 17 arranged according to the combination solution can further improve the cutting efficiency and service life.

### First Solution:

On the cutting surface 7 of the spade drill blade 17 which rotates around the axial center, a spade drill blade 17 is formed in a way of arranging an erected micro strengthened stepping table 3 on the cutting surface at a position which has a distance from the axial center less than or equal to one third of a width of the cutting surface, and thus has the highest cutting efficiency. A protruding stepped cutting surface integrally formed on the inner side of the micro strengthened stepping table 3 is a micro strengthened central plane 2. The micro strengthened stepping table 3 intersects with the rear cutting surface 24 to form a micro strengthened center edge 1 (which is also called a micro strengthened cutting edge). The micro strengthened stepping table 3 intersects with the micro strengthened central plane 2 to form a micro strengthened central secondary edge 28.

A stepped cutting edge formed by the intersection of the micro strengthened central plane 2 and the rear cutting surface 24 is the micro strengthened center edge 1.

### Second Solution:

On the cutting surface 7 of the spade drill blade 17 which rotates around the axial center, a spade drill blade 17 is formed in a way of arranging an erected micro strengthened stepping table 3 on the cutting surface at a position which has a distance from the axial center less than or equal to two thirds and greater than or equal to one third of a width of the cutting surface, and thus has the highest drilling stability. A protruding stepped cutting surface integrally formed on the inner side of the micro strengthened stepping table 3 is a tapping cutting surface 6. The micro strengthened stepping table 3 intersects with the rear cutting surface to form a micro strengthened tapping edge 4. The micro strengthened stepping table 3 intersects with the tapping cutting surface to form a micro strengthened tapping secondary edge 26.

### Third Solution:

On the cutting surface 7 of the spade drill blade 17 which rotates around the axial center, a spade drill blade 17 is formed in a way of arranging an erected micro strengthened stepping table 3 on the cutting surface at a position which has a distance from the axial center greater than or equal to two thirds of the width of the cutting surface, and thus has the longest service life. A recessed micro strengthened cutting surface integrally formed on an outer side of the micro strengthened stepping table 3 is a wear-resistant cutting surface 12 with recessed outer side. The micro strengthened stepping table 3 intersects with the rear cutting surface to form a micro strengthened side cutting edge 14. The secondary cutting surface 19 intersects with the wear-resistant cutting surface to form a micro strengthened wear-resistant secondary edge 25.

The micro strengthened stepping table 3 erected on the wear-resistant cutting surface 12 intersects with the cutting surface 7 to form a wear-resistant stepping edge 27. A stepped cutting edge formed by the intersection of the wear-resistant cutting surface 12 and the rear cutting surface 24 is a wear-resistant cutting edge 11.

The combined arrangement of the first solution and the second solution forms a first combination solution.

The combined arrangement of the first solution and the third solution forms a second combination solution.

The combined arrangement of the second solution and the third solution forms a third combination solution.

Alternatively, the first solution, the second solution and the third solution are combined to form a fourth combination solution.

The performance of any combination solution is more than 50% better than that of each independent solution contained therein, including repeated arrangement in different width ranges within each solution.

In above arrangement solution, a structure of a groove formed by extending the notched edge 5, which is arranged on the cutting edge of the spade drill blade 17, towards the rear cutting surface can function to break chips in time, and further improve the efficiency and prolong the service life.

A spade drill blade 17 is provided with at least one step, of which height on the corresponding rear cutting surface reduces from the chisel edge at a central towards the side edge at the outer side.

The rear cutting surfaces on both sides of the spade drill blade 17 intersect at the axial center to form the chisel edge, and both sides of the chisel edge are chamfered to form a top edge used as a reduced chisel edge.

The rear cutting surfaces on both sides of the spade drill blade 17 intersect at the axial center to form the chisel edge, and both sides of the chisel edge are chamfered to form a top edge used as a sharp edge without a chisel edge.

Cooling holes are formed in strips of a tool shank and a tool head of the spade drill blade 17.

The spade drill blade 7 is provided with multiple steps, of which heights on the corresponding rear cutting surface reduce from the chisel edge at a central towards the side edge at the outer side.

The cutting edge of the spade drill blade 17 is provided with multiple notched edges 5, and the multiple notched edges 5 extend towards the rear cutting surface to form multiple grooves.

A central plane of a step, a tapping cutting surface or a micro section with millimeter strength is provided as a groove shape in the axial direction.

An included angle between the cutting edge at the outermost side of the spade drill blade 17 and the secondary cutting edge is an acute angle or a right angle, or an obtuse angle.

In a contrast experiment carried out on a drilling machine, a twist drill with a diameter of 10.5 is tested, and is also made of M35 cobalt-containing high-speed steel. Heat treatment and production in the same batch are carried out at the same time. A drilled object is a gear finish turning machining piece that has been forged and tempered, a drilling depth is 35 mm, and blind holes are formed. A width of a micro cutting surface of the spade drill blade 17 is 1.5 mm, and a height of the micro strengthened stepping table 3 is 0.6 mm. In a case that the rotating speed and the feed rate of the twist drill with a common structure reach the limit, the rotating speed of the spade drill blade 17 can be increased by 35%, the feed rate can be improved by 50%, and the comprehensive drilling efficiency can be improved by 1.05 times. 312 holes can be drilled by the twist drill with a common structure, and 5168 holes can be drilled by the spade drill blade 17. Compared with the twist drill with a common structure, the number of holes drilled by the spade drill blade 17 is increased by sixteen or more times.

According to the above experimental results, the use efficiency and service life of the twist drill are significantly improved, providing that this structure is an effective way for prolonging the service life and improving the efficiency.

### Third Embodiment

As shown in FIG. 1 to FIG. 7, this embodiment is a comprehensive application on the basis of the first embodiment and the second embodiment, relating to a drilling tool for machining. Cutting surfaces 7 are formed on surfaces, facing a cutting direction along the axial center, of the blade 17, the bottom of each cutting surface 7 is integrally provided with a cutting groove 9, surfaces facing away from the rotation direction on a top end of the spade drill blade 17 are rear cutting surfaces 2, and surfaces facing the rotation direction on an outer side of the spade drill blade are secondary cutting surfaces 19. Each secondary cutting surface 19 intersects with the corresponding rear cutting surface 24 to form a side cutting edge 18, the cutting surface 7 intersects with the corresponding rear cutting surface 24 to form a cutting edge, each cutting surface 7 intersects with the secondary cutting surface 19 to form a secondary edge, the rear cutting surfaces on at least two sides intersect to form a chisel edge O, and each cutting surface 7 intersects with the secondary cutting surface 19 to form a side edge. Multiple micro strengthened stepping tables 3 are integrally erected on each cutting surface of the spade drill blade 17, and a protruding stepped cutting surface is integrally formed on an inner side of each micro strengthened stepping table 3. The multiple micro strengthened stepping tables 3 intersect with the corresponding rear cutting surface to form multiple micro strengthened side cutting edges. The multiple stepped cutting surfaces intersect with the corresponding rear cutting surface to form multiple stepped cutting edges. The cutting edge of the spade drill blade 17 is provided with a notched edge 5, and the notched edge 5 extends towards the rear cutting surface to form a groove. The rear cutting surfaces on both sides of the spade drill blade 17 intersect at the axial center to form the chisel edge. Both sides of the chisel edge are chamfered to form chamfered cutting surfaces, chamfered edges, and a top edge. The spade drill blade 17 is provided with positioning holes, and a positioning groove.

The micro strengthened stepping table 3 arranged on the spade drill blade 17 may have three arrangement solutions, and the three arrangement solutions have completely different effects and results.

### First Solution:

On the cutting surface 7 of the spade drill blade 17 which rotates around the axial center, a spade drill blade 17 is formed in a way of arranging an erected micro strengthened stepping table 3 on the cutting surface at a position which has a distance from the axial center less than or equal to one third of a width of the cutting surface, and thus has the highest cutting efficiency. A protruding stepped cutting surface integrally formed on the inner side of the micro strengthened stepping table 3 is a micro strengthened central plane 2. The micro strengthened stepping table 3 intersects with the rear cutting surface 24 to form a micro strengthened center edge 1 (which is also called a micro strengthened cutting edge). The micro strengthened stepping table 3 intersects with the micro strengthened central plane 2 to form a micro strengthened central secondary edge 28.

A stepped cutting edge formed by the intersection of the micro strengthened central plane 2 and the rear cutting surface 24 is the micro strengthened center edge 1.

### Second Solution:

On the cutting surface 7 of the spade drill blade 17 which rotates around the axial center, a spade drill blade 17 is formed in a way of arranging an erected micro strengthened stepping table 3 on the cutting surface at a position which has a distance from the axial center less than or equal to two thirds and greater than or equal to one third of a width of the cutting surface, and thus has the highest drilling stability. A protruding stepped cutting surface integrally formed on the inner side of the micro strengthened stepping table 3 is a tapping cutting surface 6. The micro strengthened stepping table 3 intersects with the rear cutting surface to form a micro strengthened tapping edge 4. The micro strengthened stepping table 3 intersects with the tapping cutting surface to form a micro strengthened tapping secondary edge 26.

### Third Solution:

On the cutting surface 7 of the spade drill blade 17 which rotates around the axial center, a spade drill blade 17 is formed in a way of arranging an erected micro strengthened stepping table 3 on the cutting surface at a position which has a distance from the axial center greater than or equal to two thirds of the width of the cutting surface, and thus has the longest service life. A recessed micro strengthened cutting surface integrally formed on an outer side of the micro strengthened stepping table 3 is a wear-resistant cutting surface 12 with recessed outer side. The micro strengthened stepping table 3 intersects with the rear cutting surface to form a micro strengthened side cutting edge 14. The secondary cutting surface 19 intersects with the wear-resistant cutting surface to form a micro strengthened wear-resistant secondary edge 25. The micro strengthened stepping table 3 erected on the wear-resistant cutting surface 12 intersects with the cutting surface 7 to form a wear-resistant stepping edge 27. A stepped cutting edge formed by the intersection of the wear-resistant cutting surface 12 and the rear cutting surface 24 is a wear-resistant cutting edge 11.

The combined arrangement of the first solution and the second solution forms a first combination solution.

The combined arrangement of the first solution and the third solution forms a second combination solution.

The combined arrangement of the second solution and the third solution forms a third combination solution.

Alternatively, the first solution, the second solution and the third solution are combined to form a fourth combination solution

In above different solutions or different combination solutions, a structure of a groove formed by extending the notched edge 5, which is arranged on the cutting edge, towards the rear cutting surface can function to break chips in time.

In above different combination solutions, a structure of a groove formed by extending the notched edge 5, which is arranged on the cutting edge of the spade drill blade 17, towards the rear cutting surface can function to break chips in time, and further improve the efficiency and prolong the service life.

A spade drill blade 17 is provided with at least one step, of which height on the corresponding rear cutting surface reduces from the chisel edge at a central towards the side edge at the outer side.

The cutting edge of the spade drill blade 17 is provided with at least one notched edge 5, and the notched edge 5 extends towards the rear cutting surface to form at least one groove.

The rear cutting surfaces on both sides of the spade drill blade 17 intersect at the axial center to form the chisel edge, and both sides of the chisel edge are chamfered to form a top edge used as a reduced chisel edge.

The rear cutting surfaces on both sides of the spade drill blade 17 intersect at the axial center to form the chisel edge, and both sides of the chisel edge are chamfered to form a top edge O) used as a sharp edge without a chisel edge.

Cooling holes are formed in strips of a tool shank and a tool head of the spade drill blade 17.

The spade drill blade 7 is provided with multiple steps, of which heights on the corresponding rear cutting surface reduce from the chisel edge at a central towards the side edge at the outer side.

The cutting edge of the spade drill blade 17 is provided with multiple notched edges 5, and the multiple notched edges 5 extend towards the rear cutting surface to form multiple grooves 22.

A central plane of a step, a tapping cutting surface or a micro section with millimeter strength is provided as a groove shape in the axial direction.

An included angle between the cutting edge at the outermost side of the spade drill blade 17 and the secondary cutting edge is an acute angle or a right angle, or an obtuse angle.

In a contrast experiment carried out on a drilling machine, a twist drill with a diameter of 10.5 is tested, and is also made of M35 cobalt-containing high-speed steel. Heat treatment and production in the same baich are carried out at the same time. A drilled object is a gear finish turning machining piece that has been forged and tempered, a drilling depth is 35 mm, and blind holes are formed. A width of a micro cutting surface of the spade drill blade 17 is 1.5 mm, and a height of the micro strengthened stepping table 3 is 0.6 mm. In a case that the rotating speed and the feed rate of the twist drill with a common structure reach the limit, the rotating speed of the spade drill blade 17 can be increased by 35%, the feed rate can be improved by 50%, and the comprehensive drilling efficiency can be improved by 1.05 times. 312 holes can be drilled by the twist drill with a common structure, and 6268 holes can be drilled by the spade drill blade 17. Compared with the twist drill with a common structure, the number of holes drilled by the spade drill blade 17 is increased by twenty or more times.

According to the above experimental results, the use efficiency and service life of the twist drill are significantly improved, providing that this structure is an effective way for prolonging the service life and improving the efficiency.

On the basis of the first to the third embodiment, a chisel edge O formed by the intersection of the rear cutting surfaces on both sides is comprehensively and selectively applied, and both ends of the chisel edge O are chamfered to form a chamfered cutting surfaces, and chamfered edges. An original chisel edge O is chamfered to form a reduced chisel edge O, or a sharp edge O without a chisel edge O. The reduction or elimination of the chisel edge greatly reduces the high resistance caused by overlong chisel edge.

While the above description has taken the spade drill blade 17 with two cutting surfaces as an example, the spade drill blade 17 provided by the present disclosure may also have multiple cutting surfaces, and the structures of the above embodiments and other various combinations thereof may be employed on each cutting surface.

### Fourth Embodiment

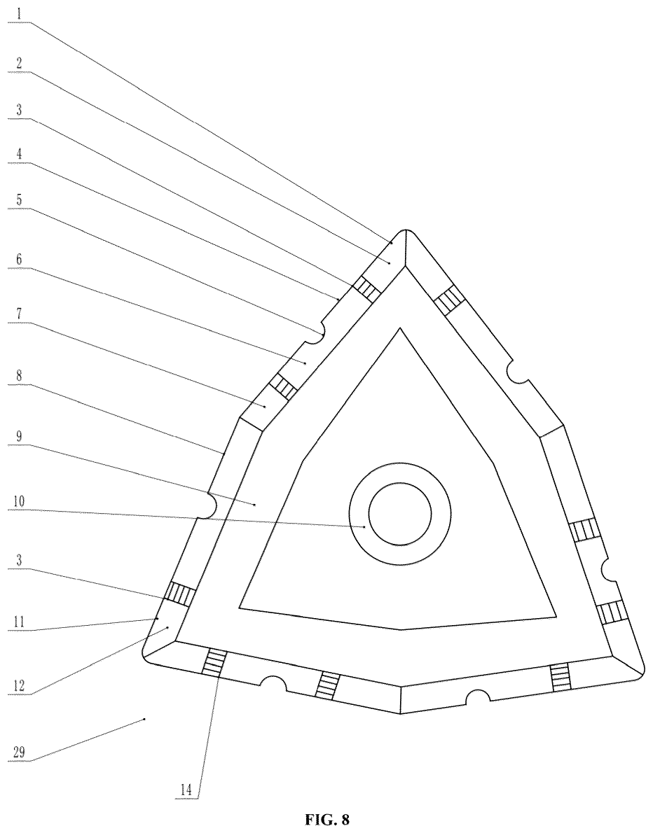

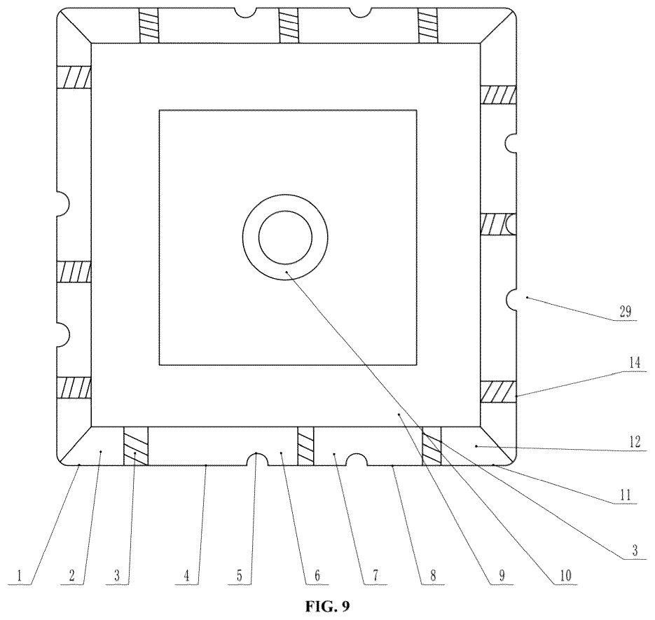

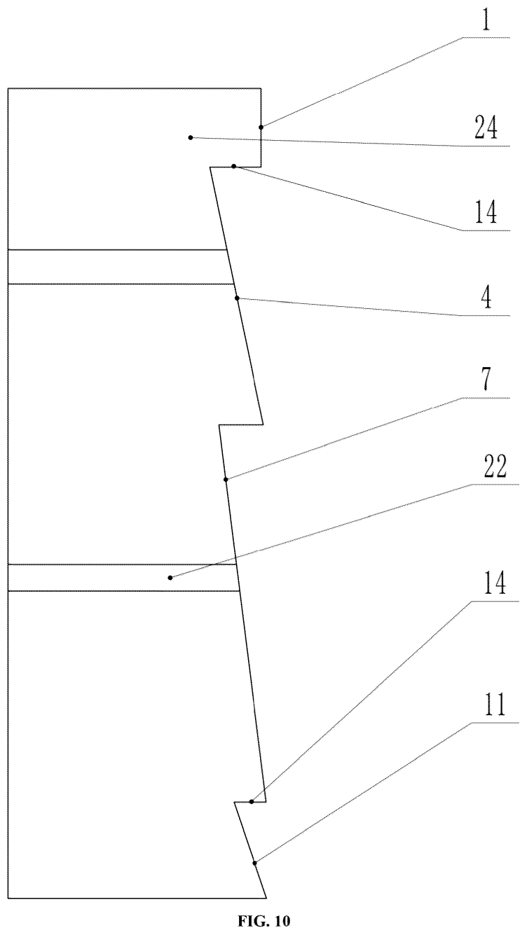

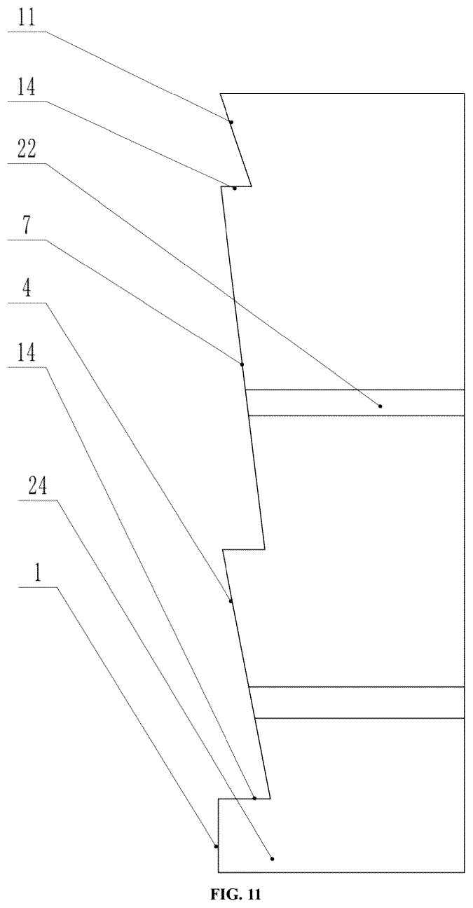

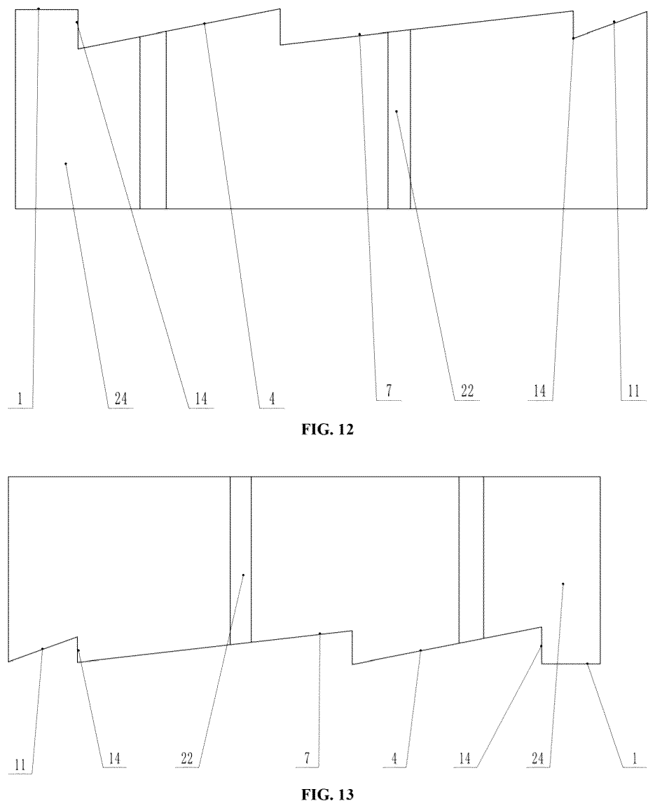

As shown in FIG. 8 to FIG. 13, FIG. 8 is a triangular combined blade with three cutting technologies, FIG. 9 is a quadrangular combined blade 29 with three cutting technologies, and FIG. 10 to FIG. 13 are an embodiment of a combined blade 29 according to the first embodiment. At least two combined blades 29 are fixed to a combined tool for machining by screws, which are used for cutting in cooperation, each combined blade 29 is integrally composed of structures in at least one or more cutting directions, the structure in each cutting direction can complete independently partial cutting operation of the combined tool, and cutting surfaces 7 are formed on surfaces, facing the cutting direction, of the combined blade 29. A cutting groove 9 is integrally formed on a bottom of each cutting surface 7, surfaces facing away from the rotation direction on a top end of the combined blade 29 are rear cutting surfaces 24, and each cutting surface 7 intersects with the corresponding rear cutting surface 24 to form a cutting edge 8. Structures of the combined blade 29 in the cutting directions are all structures of the combined blade 29 which participate in cutting or secondary cutting in the combined tool at the same time. In each cutting process, the combined blade 29 has the structure in only cutting direction structure to participate in cutting operation, and the structures in other cutting directions are replacement for damage and are fixed by screws.

A micro strengthened stepping table 3 is integrally erected on each cutting surface 7 of the combined blade 29, and a protruding stepped cutting surface (a micro strengthened central plane 2, a tapping cutting surface 6, a wear-resistant cutting surface 12 with recessed outer side) is integrally formed on an inner side of the micro strengthened stepping table 3. The micro strengthened stepping table 3 intersects with the corresponding rear cutting surface 24 to form a micro strengthened side cutting edge 14. The stepped cutting surface intersects with the rear cutting surface to form a stepped cutting edge (a micro strengthened center edge 1, a micro strengthened tapping edge 4, and a wear-resistant cutting edge 11). The combined blade 29 is provided with positioning holes 10.

The combined blade 29 is generally a triangular configuration with structures in three cutting directions. One end of a structure in each cutting direction is adjacent to a central position of the combined tool, and the other end of the structure in each cutting direction is adjacent to the outer side of the combined tool.

The combined blade 29 is generally a quadrangular configuration with structures in four cutting directions. One end of a structure in each cutting direction is adjacent to the central position of the combined tool, and the other end of the structure in each cutting direction is adjacent to an outer side of the combined tool.

The combined blade 29 is provided with a structure in at least one cutting direction, and the structures in the cutting directions include all structures of the combined blade 29 which participate in cutting or secondary cutting in the combined tool at the same time.

A surface in a front of the rotation direction of the combined blade 29 is inclined backwards to fit with a body of the spade drill blade to form an inclined plane 23.

The micro strengthened stepping table 3 arranged on the combined blade 29 may have three arrangement solutions, and the three arrangement solutions have completely different effects and results.

### First Solution:

On the cutting surface 7 of the combined blade 29 which rotates around the axial center, a combined blade 29 is formed in a way of arranging an erected micro strengthened stepping table 3 on the cutting surface at a position which is less than or equal to one third of a width of the cutting surface, and thus has the highest cutting efficiency. A protruding stepped cutting surface integrally formed on the inner side of the micro strengthened stepping table 3 is a micro strengthened central plane 2. The micro strengthened stepping table 3 intersects with the rear cutting surface 24 to form a micro strengthened center edge 1 (which is also called a micro strengthened cutting edge).

A stepped cutting edge formed by the intersection of the micro strengthened central plane 2 and the rear cutting surface 24 is a micro strengthened center edge 1.

### Second Solution:

On the cutting surface 7 of the combined blade 29 which rotates around the axial center, a combined blade 29 is formed in a way of arranging an erected micro strengthened stepping table 3 on the cutting surface at a position which is less than or equal to two thirds and greater than or equal to one third of a width of the cutting surface, and thus has the highest drilling stability. A protruding stepped cutting surface integrally formed on the inner side of the micro strengthened stepping table 3 is a tapping cutting surface 6. The micro strengthened stepping table 3 intersects with the rear cutting surface to form a micro strengthened tapping edge 4.

### Third Solution:

On the cutting surface 7 of the combined blade 29 which rotates around the axial center, a combined blade 29 is formed in a way of arranging an erected micro strengthened stepping table 3 on the cutting surface at a position which is greater than or equal to two thirds of the width of the cutting surface, and thus has the longest service life. A recessed micro strengthened cutting surface integrally formed on an outer side of the micro strengthened stepping table 3 is a wear-resistant cutting surface 12 with recessed outer side. The micro strengthened stepping table 3 intersects with the rear cutting surface to form a micro strengthened side cutting edge 14. A stepped cutting edge formed by the intersection of the wear-resistant cutting surface 12 and the rear cutting surface 24 is a wear-resistant cutting edge 11.

In the above arrangement solution, a structure of a groove formed by extending the notched edge 5, which is arranged on the cutting edge of the combined blade 29, towards the rear cutting surface can function to break chips in time, and further improve the efficiency and prolong the service life.

The combined blade 29 is provided with at least one step, of which height on the corresponding rear cutting surface reduces from the center towards the side edge at the outer side.

The cutting edge of the combined blade 29 is provided with at least one notched edge 5, and the notched edge 5 extends towards the corresponding rear cutting surface to form at least one groove 22

The combined blade 29 is provided with multiple steps (not shown), of which heights on the corresponding rear cutting surface 24 reduce from the chisel edge at a central towards the side edge 18 at the outer side.

The cutting edge of the combined blade 29 is provided with multiple notched edges S, and the multiple notched edges 5 extend towards the corresponding rear cutting surface to form multiple grooves.

According to the above structure, because cutting of drilling is a circular movement, a centrifugal force is generated in the process of the circular movement, the cutting edge forms a transmission carrier of a centrifugal force. The cutting edge is separated by a micro cutting edge, a side micro edge and a cutting micro edge, which are formed by the intersection of the cutting surface and an adjacent micro strengthened stepping table 3 and the intersection of a micro cutting surface with the millimeter strength and the rear cutting surface, thus disintegrating the transmission force, thus reducing the overall cutting resistance, reducing the force on cutting edge and the cutting edge formed by the intersection of the cutting surface on the outer side and the rear cutting surface to the greatest extent, reducing the temperature of the tool head, decomposing the force on the cutting edge at the most easily damaged outer end of the tool, prolonging the service life of the tool, and maintaining high strength all the time during machining.

In a contrast experiment carried out on a drilling machine, a twist drill with a diameter of 10.5 is tested, and is also made of M35 cobalt-containing high-speed steel. Heat treatment and production in the same batch are carried out at the same time. A drilled object is a gear finish turning machining piece that has been forged and tempered, a drilling depth is 35 mm, and blind holes are formed. A width of a micro cutting surface of the combined blade 29 is 1.5 mm, and a height of the micro strengthened stepping table 3 is 0.6 mm. In a case that the rotating speed and the feed rate of the twist drill with a common structure reach the limit, the rotating speed of the combined blade 29 can be increased by 35%, the feed rate can be improved by 50%, and the comprehensive drilling efficiency can be improved by 1.05 times. 312 holes can be drilled by the twist drill with a common structure, and 3168 holes can be drilled by the combined blade 29. Compared with the twist drill with a common structure, the number of holes drilled by the combined blade 29 is increased by ten or more times.

According to the above experimental results, the use efficiency and service life of the twist drill are significantly improved, providing that this structure is an effective way for prolonging the service life and improving the efficiency.

### Fifth Embodiment

As shown in FIG. 8 to FIG. 13, in this embodiment, on the basis of the fourth embodiment, FIG. 8 of the present disclosure is a triangular combined blade 29 with three cutting technologies in combined arrangement, FIG. 9 is a quadrangular combined blade 29 with three cutting technologies in combined arrangement, and FIG. 10 to FIG. 13 are an embodiment of a combined blade 29 according to the fourth embodiment. At least two combined blades 29 are fixed to a combined tool for machining by screws, which are used for cutting in cooperation, each combined blade 29 is integrally composed of structures in at least one or more directions, the structure in each cutting direction can complete independently partial cutting operation of the combined tool, and cutting surfaces 7 are formed on surfaces, facing the cutting direction, of the combined blade 29. A cutting groove 9 is integrally formed on a bottom of each cutting surface 7, surfaces facing away from the rotation direction on a top end of the combined blade 29 are rear cutting surfaces 24, and each cutting surface 7 intersects with the corresponding rear cutting surface 24 to form a cutting edge 8. Structures of the combined blade 29 in the cutting directions are all structures of the combined blade 29 which participate in cutting or secondary cutting in the combined tool at the same time. In each cutting process, the combined blade 29 has the structure in only cutting direction structure to participate in cutting operation, and the structures in other cutting directions are replacement for damage and are fixed by screws.

Multiple micro strengthened stepping tables 3 are integrally erected on each cutting surface 7 of the combined blade 29, and a protruding stepped cutting surface (a micro strengthened central plane 2, a tapping cutting surface 6, and a wear-resistant cutting surface 12 with recessed outer side) is integrally formed on an inner side of each micro strengthened stepping table 3. The multiple micro strengthened stepping tables 3 intersect with the corresponding rear cutting surface to form multiple micro strengthened side cutting edges. The multiple stepped cutting surfaces intersect with the corresponding rear cutting surface to form multiple stepped cutting edges. The combined blade 29 is provided with positioning holes 10, and a positioning groove.

According to the present disclosure, two of the three arrangement solutions of the micro strengthened stepping table 3 arranged on the combined blade 29 are combined, and the combined blade 29 arranged according to the combined solution can further improve the cutting efficiency and prolong the service life:

### First Solution:

On the cutting surface 7 of the combined blade 29 which rotates around the axial center, a combined blade 29 is formed in a way of arranging an erected micro strengthened stepping table 3 on the cutting surface at a position which is less than or equal to one third of a width of the cutting surface, and thus has the highest cutting efficiency. A protruding stepped cutting surface integrally formed on the inner side of the micro strengthened stepping table 3 is a micro strengthened central plane 2. The micro strengthened stepping table 3 intersects with the rear cutting surface 24 to form a micro strengthened center edge 1 (which is also called a micro strengthened cutting edge).

A stepped cutting edge formed by the intersection of the micro strengthened central plane 2 and the rear cutting surface 24 is the micro strengthened center edge 1.

### Second Solution:

On the cutting surface 7 of the combined blade 29 which rotates around the axial center, a combined blade 29 is formed in a way of arranging an erected micro strengthened stepping table 3 on the cutting surface at a position which is less than or equal to two thirds and greater than or equal to one third of a width of the cutting surface, and thus has the highest drilling stability. A protruding stepped cutting surface integrally formed on the inner side of the micro strengthened stepping table 3 is a tapping cutting surface 6. The micro strengthened stepping table 3 intersects with the rear cutting surface to form a micro strengthened tapping edge 4. Third solution:

On the cutting surface 7 of the combined blade 29 which rotates around the axial center, a combined blade 29 is formed in a way of arranging an erected micro strengthened stepping table 3 on the cutting surface at a position which is greater than or equal to two thirds of the width of the cutting surface, and thus has the longest service life. A recessed micro strengthened cutting surface integrally formed on an outer side of the micro strengthened stepping table 3 is a wear-resistant cutting surface 12 with recessed outer side. The micro strengthened stepping table 3 intersects with the rear cutting surface to form a micro strengthened side cutting edge 14. A stepped cutting edge formed by the intersection of the wear-resistant cutting surface 12 and the rear cutting surface 24 is a wear-resistant cutting edge 11.

The combined arrangement of the first solution and the second solution forms a first combination solution.

The combined arrangement of the first solution and the third solution forms a second combination solution.

The combined arrangement of the second solution and the third solution forms a third combination solution.

Alternatively, the first solution, the second solution and the third solution are combined to form a fourth combination solution.

The performance of any combination solution is more than 50% better than that of each independent solution contained therein, including repeated arrangement in different width ranges within each solution.

In above arrangement solution, a structure of a groove formed by extending the notched edge 5, which is arranged on the cutting edge of the combined blade 29, towards the rear cutting surface can function to break chips in time, and further improve the efficiency and prolong the service life.

The combined blade 29 is provided with at least one step, of which height on the corresponding rear cutting surface reduces from the center towards the side edge at the outer side.

The combined blade 29 is provided with multiple steps, of which heights on the corresponding rear cutting surface reduce from the center towards the side edge at the outer side.

The cutting edge of the combined blade 29 is provided with multiple notched edges 5, and the multiple notched edges 5 extend towards the rear cutting surface to form multiple grooves.

The central plane of a step, a tapping cutting surface or a micro cutting surface with the millimeter strength is provided as the groove shape in the axial direction.

In a contrast experiment carried out on a drilling machine, a twist drill with a diameter of 10.5 is tested, and is also made of M35 cobalt-containing high-speed steel. Heat treatment and production in the same batch are carried out at the same time. A drilled object is a gear finish turning machining piece that has been forged and tempered, a drilling depth is 35 mm, and blind holes are formed. A width of a micro cutting surface of the combined blade 29 is 1.5 mm, and a height of the micro strengthened stepping table 3 is 0.6 mm. In a case that the rotating speed and the feed rate of the twist drill with a common structure reach the limit, the rotating speed of the combined blade 29 can be increased by 35%, the feed rate can be improved by 50%, and the comprehensive drilling efficiency can be improved by 1.05 times. 312 holes can be drilled by the twist drill with a common structure, and 5168 holes can be drilled by the combined blade 29. Compared with the twist drill with a common structure, the number of holes drilled by the combined blade 29 is increased by sixteen or more times.

According to the above experimental results, the use efficiency and service life of the twist drill are significantly improved, providing that this structure is an effective way for prolonging the service life and improving the efficiency.

### Sixth Embodiment

As shown in FIG. 8 to FIG. 13, in this embodiment, on the basis of the fourth embodiment and the fifth embodiment, FIG. 8 of the present disclosure is a triangular combined blade 29 with three cutting technologies in combined arrangement, a cutting edge of the combined blade 29 is provided with a notched edge 5, and the notched edge extends towards a rear cutting surface to form a groove. FIG. 9 is a quadrangular combined blade 29 with three cutting technologies in combined arrangement, and FIG. 10 to FIG. 13 are an embodiment of a combined blade 29 according to the sixth embodiment. At least two combined blades 29 are fixed to a combined tool for machining by screws, which are used for cutting in cooperation each combined blade 29 is integrally composed of structures in at least one or more directions, the structure in each cutting direction can complete independently partial cutting operation of the combined tool, and cutting surfaces 7 are formed on surfaces, facing the cutting direction, of the combined blade 29. A cutting groove 9 is integrally formed on a bottom of each cutting surface 7, surfaces facing away from the rotation direction on a top end of the combined blade 29 are rear cutting surfaces 24, and each cutting surface 7 intersects with the corresponding rear cutting surface 24 to form a cutting edge 8. Structures of the combined blade 29 in the cutting directions are all structures of the combined blade 29 which participate in cutting or secondary cutting in the combined tool at the same time. In each cutting process, the combined blade 29 has the structure in only cutting direction structure to participate in cutting operation, and the structures in other cutting directions are replacement for damage and are fixed by screws.

Multiple micro strengthened stepping tables 3 are integrally erected on each cutting surface 7 of the combined blade 29, and a protruding stepped cutting surface (a micro strengthened central plane 2, a tapping cutting surface 6, and a wear-resistant cutting surface 12 with recessed outer side) is integrally formed on an inner side of each micro strengthened stepping table 3. The multiple micro strengthened stepping tables 3 intersect with the corresponding rear cutting surface to form multiple micro strengthened side cutting edges. The multiple stepped cutting surfaces intersect with the corresponding rear cutting surface to form multiple stepped cutting edges. The cutting edge of the combined blade 29 is provided with a notched edge 5, and the notched edge extends towards a corresponding rear cutting surface to form a groove. The combined blade 29 is provided with positioning holes, and a positioning groove.

The micro strengthened stepping table 3 arranged on the combined blade 29 may have three arrangement solutions, and the three arrangement solutions have completely different effects and results.

### First Solution:

On the cutting surface 7 of the combined blade 29 which rotates around the axial center, a combined blade 29 is formed in a way of arranging an erected micro strengthened stepping table 3 on the cutting surface at a position which is less than or equal to one third of a width of the cutting surface, and thus has the highest cutting efficiency. A protruding stepped cutting surface integrally formed on the inner side of the micro strengthened stepping table 3 is a micro strengthened central plane 2. The micro strengthened stepping table 3 intersects with the rear cutting surface 24 to form a micro strengthened center edge 1 (which is also called a micro strengthened cutting edge).

A stepped cutting edge formed by the intersection of the micro strengthened central plane 2 and the rear cutting surface 24 is the micro strengthened center edge 1.

### Second Solution:

On the cutting surface 7 of the combined blade 29 which rotates around the axial center, a combined blade 29 is formed in a way of arranging an erected micro strengthened stepping table 3 on the cutting surface at a position which is less than or equal to two thirds and greater than or equal to one third of a width of the cutting surface, and thus has the highest drilling stability. A protruding stepped cutting surface integrally formed on the inner side of the micro strengthened stepping table 3 is a tapping cutting surface 6. The micro strengthened stepping table 3 intersects with the rear cutting surface to form a micro strengthened tapping edge 4.

### Third Solution:

On the cutting surface 7 of the combined blade 29 which rotates around the axial center, a combined blade 29 is formed in a way of arranging an erected micro strengthened stepping table 3 on the cutting surface at a position which is greater than or equal to two thirds of the width of the cutting surface, and thus has the longest service life. A recessed micro strengthened cutting surface integrally formed on an outer side of the micro strengthened stepping table 3 is a wear-resistant cutting surface 12 with recessed outer side. The micro strengthened stepping table 3 intersects with the rear cutting surface to form a micro strengthened side cutting edge 14. A stepped cutting edge formed by the intersection of the wear-resistant cutting surface 12 and the rear cutting surface 24 is a wear-resistant cutting edge 11.

The combined arrangement of the first solution and the second solution forms a first combination solution.

The combined arrangement of the first solution and the third solution forms a second combination solution.

The combined arrangement of the second solution and the third solution forms a third combination solution.

Alternatively, the first solution, the second solution and the third solution are combined to form a fourth combination solution.

In above different solutions or different combination solutions, a structure of a groove formed by extending the notched edge 5, which is arranged on the cutting edge, towards the rear cutting surface can function to break chips in time.

In above different combination solutions, a structure of a groove formed by extending the notched edge 5, which is arranged on the cutting edge of the combined blade 29, towards the rear cutting surface can function to break chips in time, and further improve the efficiency and prolong the service life.

A combined blade 29 is provided with at least one step, of which height on the corresponding rear cutting surface reduces from the center towards the side edge at the outer side.

The cutting edge of the combined blade 29 is provided with at least one notched edge 5, and the notched edge 5 extends towards the rear cutting surface to form at least one groove 22.

The combined blade 29 is provided with multiple steps, of which heights on the corresponding rear cutting surface reduce from the center towards the side edge at the outer side.

The cutting edge of the combined blade 29 is provided with multiple notched edges 5, and the notched edges 5 extend towards the rear cutting surface to form multiple grooves 22.

A central plane of a step, a tapping cutting surface or a micro section with millimeter strength is provided as a groove shape in the axial direction.

In a contrast experiment carried out on a drilling machine, a twist drill with a diameter of 10.5 is tested, and is also made of M35 cobalt-containing high-speed steel. Heat treatment and production in the same batch are carried out at the same time. A drilled object is a gear finish turning machining piece that has been forged and tempered, a drilling depth is 35 mm, and blind holes are formed. A width of a micro cutting surface of the combined blade 29 is 1.5 mm, and a height of the micro strengthened stepping table 3 is 0.6 mm. In a case that the rotating speed and the feed rate of the twist drill with a common structure reach the limit, the rotating speed of the combined blade 29 can be increased by 35%, the feed rate can be improved by 50%, and the comprehensive drilling efficiency can be improved by 1.05 times. 312 holes can be drilled by the twist drill with a common structure, and 6268 holes can be drilled by the combined blade 29. Compared with the twist drill with a common structure, the number of holes drilled by the combined blade 29 is increased by sixteen or more times.

According to the above experimental results, the use efficiency and service life of the twist drill are significantly improved, providing that this structure is an effective way for prolonging the service life and improving the efficiency.

Although the combined blade 29 has been described above by taking the structural triangular combined blade 29 with three cutting directions and the structural quadrangular combined blade 29 with three cutting directions as an example, the combined blade 29 of the present disclosure is arranged with structures in one or two or more cutting directions, and the structure in each cutting direction may employ the structures of the embodiments and other various combinations thereof.

The preferred embodiments described above are illustrative and not restrictive. The present disclosure may be implemented and embodied in other ways without departing from the substance and essential characteristics of the present disclosure, the scope of which is defined by the claims. All variations that come within the scope of the claims are intended to fall within the scope of the present disclosure.

What is claimed is:

1. A spade drill blade, relating to a drilling tool for machining, wherein cutting surfaces are formed on surfaces, facing a cutting direction along an axial center, of the spade drill blade, a cutting groove is integrally formed on a bottom of each cutting surface; and the cutting surfaces are formed on surfaces, facing the cutting direction and along a rotation direction around the axial center, of the spade drill blade; surfaces facing away from the rotation direction on a top end of the spade drill blade are rear cutting surfaces, and surfaces facing the rotation direction on an outer side of the spade drill blade are secondary cutting surfaces; each cutting surface intersects with a corresponding rear cutting surface to form a cutting edge, each cutting surface intersects with a corresponding secondary cutting surface to form a secondary edge, the rear cutting surfaces on at least two sides of the spade drill blade intersect to form a chisel edge, and each secondary cutting surface intersects with a corresponding rear cutting surface to form a side edge; a micro strengthened stepping table is integrally erected on each cutting surface of the spade drill blade, a protruding stepped cutting surface is integrally formed on an inner side of the micro strengthened stepping table; the micro strengthened stepping table intersects with the corresponding rear cutting surface to form a micro strengthened side cutting edge; the stepped cutting surface intersects with the corresponding rear cutting surface to form a stepped cutting edge; the rear cutting surfaces on both sides of the spade drill blade intersect at the axial center to form the chisel edge; both sides of the chisel edge are chamfered to form chamfered cutting surfaces, chamfered edges, and a top edge; and the spade drill blade is provided with positioning holes, and a positioning groove.

2. The spade drill blade according to claim 1, wherein multiple micro strengthened stepping tables are integrally erected on each cutting surface of the blade, a protruding stepped cutting surface is integrally formed on an inner side of each micro strengthened stepping table; each micro strengthened stepping table intersects with the corresponding rear cutting surface to form a micro strengthened side cutting edge; the stepped cutting surface intersects with the corresponding rear cutting surface to form a stepped cutting edge.

3. The spade drill blade according to claim 2, wherein the cutting edge of the spade drill blade is provided with a notched edge, the notched edge extends towards the corresponding rear cutting surface to form a groove.

4. The spade drill blade according to claim 1, wherein the spade drill blade is provided with at least one step, of which a height on the corresponding rear cutting surface reduces from the chisel edge at a central towards the side edge at the outer side.

5. The spade drill blade according to claim 1, wherein the cutting edge of the spade drill blade is provided with at least one notched edge, and the notched edge extends towards the corresponding rear cutting surface to form at least one groove.

6. The spade drill blade according to claim 1, wherein the rear cutting surfaces on both sides of the spade drill blade intersect at the axial center to form the chisel edge, and both sides of the chisel edge are chamfered to form a top edge used as a reduced chisel edge.

7. The spade drill blade according to claim 1, wherein the rear cutting surfaces on both sides of the spade drill blade intersect at the axial center to form the chisel edge, and both sides of the chisel edge are chamfered to form a top edge used as a sharp edge without a chisel edge.

8. The spade drill blade according to claim 1, wherein cooling holes are formed in strips of a tool shank and a tool head of the spade drill blade.

9. The spade drill blade according to claim 1, wherein the spade drill blade is provided with multiple steps, of which heights on the corresponding rear cutting surface reduce from the chisel edge at a central towards the side edge at the outer side.

10. The spade drill blade according to claim 1, wherein the cutting edge of the spade drill blade is provided with a plurality of notched edges, and the plurality of notched edges extend towards the corresponding rear cutting surface to form a plurality of grooves.

11. A combined blade, comprising at least two combined blades fixed to a combined tool for machining by screws, each combined blade is integrally composed of structures in at least one or more cutting directions, a structure in each cutting direction complete independently partial cutting operation of the combined tool, and cutting surfaces are formed on surfaces, facing the cutting direction, of the combined blade; a cutting groove is integrally formed on a bottom of each cutting surface, and the cutting surfaces are formed on surfaces, facing a front of a rotation direction, of the combined blade; surfaces facing away from the rotation direction on a top end of the combined blade are rear cutting surfaces, and each cutting surface intersects with a corresponding rear cutting surface to form a cutting edge; on each cutting surface of the combined blade, a micro strengthened stepping table is integrally erected in an axial direction of the rotation center of the combined tool, and a protruding stepped cutting surface is integrally formed on an inner side of the micro strengthened stepping table; the structures of the combined blade in the cutting directions are all structures of the combined blade which participate in cutting or secondary cutting in the combined tool at the same time; the micro strengthened stepping table intersects with the corresponding rear cutting surface to form a side cutting edge; the stepped cutting surface intersects with the corresponding rear cutting surface to form a micro strengthened stepped cutting edge, and the combined blade is provided with positioning holes.

12. The combined blade according to claim 11, wherein multiple micro strengthened stepping tables are integrally erected in an axial direction of the rotation center of the combined tool, and a protruding stepped cutting surface is integrally formed on an inner side of each micro strengthened stepping table; the structures of the combined blade in the cutting directions are all structures of the combined blade which participate in cutting or secondary cutting in the combined tool at the same time; each micro strengthened stepping table intersects with the corresponding rear cutting surface to form a side cutting edge; the stepped cutting surface intersects with the corresponding rear cutting surface to form a micro strengthened stepped cutting edge.

13. The combined blade according to claim 12, wherein the cutting edge of the combined blade is provided with a notched edge, and the notched edge extends towards the corresponding rear cutting surface to form a groove.

14. The combined blade according to claim 11, wherein the combined blade is provided with at least one step, of which a height on the corresponding rear cutting surface of the combined blade reduces from a position adjacent to the axial center towards an outer side of the combined tool.

15. The combined blade according to claim 11, wherein the cutting edge of the combined blade is provided with at least one notched edge, and the notched edge extends towards the corresponding rear cutting surface to form at least one groove.

16. The combined blade according to claim 11, wherein the combined blade is generally a triangular configuration with structures in three cutting directions, one end of a structure in each cutting direction is adjacent to a central position of the combined tool, and another end of the structure in each cutting direction is adjacent to an outer side of the combined tool.

17. The combined blade according to claim 11, wherein the combined blade is generally a quadrangular configuration with structures in four cutting directions, one end of a structure in each cutting direction is adjacent to a central position of the combined tool, and another end of the structure in each cutting direction is adjacent to an excircle position of the combined tool.

18. The combined blade according to claim 11, wherein the combined blade is provided with a structure in at least one cutting direction, and the structure in the cutting direction comprises a cutting edge, a notched edge, or a stepped edge.

19. The combined blade according to claim 11, wherein the combined blade is provided with multiple steps, of which heights on the corresponding rear cutting surface reduce from the chisel edge at a central towards the side edge at the outer side.

20. The combined blade according to claim 11, wherein the cutting edge of the combined blade is provided with a plurality of notched edges, and the plurality of notched edges extend towards the corresponding rear cutting surface to form a plurality of grooves.
